(19) United States
(12) Patent Application Publication
(10) Pub. No.: US 2015/0363294 A1
(43) Pub. Date: Dec. 17, 2015

(54) Systems And Methods For Software Analysis

(71) Applicant: The Charles Stark Draper Laboratory Inc., Cambridge, MA (US)

(72) Inventors: Richard T. Carback, III, Everett, MA (US); Brad D. Gaynor, Newton, MA (US); Neil A. Brock, Acton, MA (US); Nathan R. Shnidman, Lexington, MA (US)

(21) Appl. No.: 14/735,639

(22) Filed: Jun. 10, 2015

Related U.S. Application Data
(60) Provisional application No. 62/012,127, filed on Jun. 13, 2014.

(51) Int. Cl. G06F 11/36

(52) U.S. Cl. CPC G06F 11/3672; G06F 11/362

(57) ABSTRACT

Systems, methods, and computer program products are provided for identifying software files, flaws in code, and program fragments by obtaining a software file, determining a plurality of artifacts, accessing a database which stores a plurality of reference artifacts for reference software files, comparing at least one of the artifacts to at least one of the reference artifacts stored in the database, and identifying the software file by identifying the reference software file having the reference artifacts that correspond to the plurality of artifacts. Certain embodiments can also automatically provide updated versions of files, patches to be applied, or repaired blocks of code to replace flawed blocks. Example embodiments can accept a wide variety of file types, including source code and binary files and can analyze source code or convert files to an intermediate representation (IR) and analyze the IR.

### RELATED APPLICATION(S)

This application claims the benefit of U.S. Provisional Application No. 62/012,127, filed on Jun. 13, 2014. The entire teachings of the above application are incorporated herein by reference.

### GOVERNMENT SUPPORT

This invention was made with government support under grant number FA8750-14-C-0056 from the United States Air Force and grant number FA8750-15-C-0242 from the Defense Advanced Research Projects Agency. The government has certain rights in the invention.

### BACKGROUND OF THE INVENTION

Today, software development, maintenance, and repair are manual processes. Software vendors plan, implement, document, test, deploy, and maintain computer programs over time. The initial plans, implementations, documentation, tests, and deployments are often incomplete and invariably lack desired features or contain flaws. Many vendors have lifecycle maintenance plans to address these shortcomings by pushing iterative bug fixes, security patches, and feature enhancements as the software matures.

There is a large amount of software code deployed in the world, billions of lines, and maintenance and bug fixes take large amounts of time and money to address. Historically, software maintenance has been an ad-hoc and reactionary (i.e., responding to bug reports, security vulnerability reports, and user requests for feature enhancements) manual process.

### SUMMARY OF THE INVENTION

Embodiments of the present invention automate key aspects of the software development, maintenance, and repair lifecycle, including, for example, finding and repairing program flaws, such as bugs (errors in the code), security vulnerabilities, and protocol deficiencies. Example embodiments of the present invention provide systems and methods which can utilize large volumes of software files, including those that are publicly available or proprietary software.

Certain of the example embodiments can automatically identify and provide the newest versions or patches for software files. Additional embodiments can automatically locate design patterns, such as software flaws (e.g., bugs, security vulnerabilities, protocol deficiencies), that are known to exist in certain software files and provide repairs. Other embodiments may make use of the known flaws by locating them in software files for which it was previously unknown that the files contained the flaw. Additional embodiments can automatically locate design patterns, such as identifying portions of source or binary code, to identify files, programs, functions, or blocks of code.

When a software flaw is identified, for some embodiments, the corresponding software repair pattern can be used to generate a repair specification. This repair specification, for example, can be used to synthesize an appropriate software repair in the form of a source or binary, also referred to as machine language, patch. Certain example embodiments can support performing automatic software maintenance, such as flaw identification and repair, on both binary code and source code allowing for broad automated software maintenance for legacy systems.

According to one embodiment of the invention, a method for identifying software includes obtaining a software file, determining a plurality of artifacts for the software file, accessing a database which stores a plurality of reference artifacts for each of a plurality of reference software files, comparing the plurality of artifacts to the plurality of reference artifacts, and identifying the software file by identifying the reference software file having the plurality of reference artifacts that match the plurality of artifacts.

According to additional embodiments, the plurality of artifacts for the software file can include one or more of a call graph, control flow graph, use-def chain, def-use chain, dominator tree, basic block, variable, constant, branch semantic, and protocol. For yet other additional embodiments, the plurality of artifacts can include one or more of a system call trace and execution trace. For another example embodiment, the plurality of artifacts can include one or more of a loop invariant, type information, Z notation, and label transition system representation. For certain example embodiments, the plurality of artifacts can include one or more artifacts determined from any of an in-line code comment, commit history, documentation file, and common vulnerabilities and exposure source entry. For some example embodiments, the plurality of artifacts are each a graph artifact or a developmental artifact. For additional embodiments, the plurality of artifacts are each static artifacts, dynamic artifacts, derived artifacts, or meta data artifacts. For certain embodiments, the plurality of reference artifacts match the plurality of artifacts when at least a fuzzy match exists between the plurality of reference artifacts and the plurality of artifacts.

According to additional embodiments, the method can also determine whether a newer version of the software file exists by analyzing at least one of the reference artifacts stored in the database that is associated with the identified reference software file. For some embodiments, the method can also automatically provide the newer version of the software file.

According to other embodiments, the method can also include determining whether a patch for the software file exists by analyzing at least one of the reference artifacts associated with the identified reference software file. Certain embodiments can also automatically apply the patch to the software file. Other embodiments can also analyze the patch to determine a repair portion of the patch that corresponds to a repair of a flaw in the software file, and apply only the repair portion of the patch to the software file. For certain embodiments, analyzing the patch and the software file includes converting the patch, and the software file also for some embodiments, into an intermediate representation and determining at least one of the artifacts from the intermediate representation.

Certain embodiments of the present invention can determine the plurality of artifacts for the software file by converting the software file into an intermediate representation and determining at least one of the plurality of artifacts from the intermediate representation. Additional embodiments may also run the software file in an instrumented environment, such as a virtual machine, to determine the artifacts. Certain embodiments may also determine some of the artifacts by extracting a string of characters from the software file, including when the software file is in source code format or binary code format.

Additional embodiments of the example method can determine whether a flaw exists in the software file by analyzing at least one of the reference artifacts associated with the identified reference software file, and also at least one of the artifacts associated with the software file for certain embodiments. Additional embodiments can automatically repair the flaw in the software file. For certain of these embodiments, automatically repairing the flaw includes replacing a block of source code with a repair block of source code. For certain of these embodiments, automatically repairing the flaw includes replacing a block of binary code with a repair block of binary code. For certain of these embodiments, automatically repairing the flaw includes replacing a block of intermediate representation of the software file with a repair block of intermediate representation. These blocks can be contiguous, but do not have to be, and can include code spread throughout the file.

According to another embodiment of the present invention, a method for identifying code includes obtaining one or more software files, determining a plurality of artifacts for the software files, accessing a database which stores a plurality of reference artifacts, and identifying a program fragment that is in the software file by matching the plurality of artifacts that corresponds to the program fragment to the plurality of reference artifacts that corresponds to the program fragment. The matching can also be based on fuzzy matching wherein close matches are deemed as matches.

For some embodiments, determining the plurality of artifacts for the software files includes converting the software files into an intermediate representation format and determining at least one of the plurality of artifacts from the intermediate representation. For some of the embodiments of the example method, the software files are each in a source code format. For other embodiments, the software files are each in a binary code format. For some embodiments, the program fragment corresponds to a flaw in the software file, such as a bug, a security vulnerability, or a protocol deficiency. For certain example embodiments, the plurality of artifacts include a graph artifact, and/or a developmental artifact, or are each meta data artifacts. For certain example embodiments, the one or more software files can be files within a software project.

For certain embodiments, the reference artifacts corresponding to the program fragment have previously been identified in the database to correspond to a flaw. For some embodiments, the method also includes automatically repairing the flaw in the software file, offering one or more repair options to a user to repair the flaw, and/or ordering the one or more repair options, including based on one or more previous repair options selected by the user or based on a likelihood of success for each of the repair options. Repairing a flaw automatically includes repairing a flaw without any input from a user for that file, including by referencing a configuration file, setting, or flag, including those that can be previously set by a user, such as an administrator, to determine whether repairing a flaw automatically is desired or allowed.

For certain example embodiments, the program fragment has been identified in the database to correspond to a feature. Certain embodiments can also automatically augment the feature with a feature enhancement, including by applying a binary or source code patch.

Additional embodiments of the present invention provide a system for identifying software, which includes an interface capable of communicating with a source having a software file, a storage device which stores a plurality of reference artifacts for each of a plurality of reference software files, a processor communicatively coupled to the interface and the storage device, and configured to obtain the software file, determine a plurality of artifacts for the software file, access the plurality of reference artifacts in the storage device, compare the plurality of artifacts to the plurality of reference artifacts, and identify the software file by identifying the reference software file having the plurality of reference artifacts that match the plurality of artifacts.

Additional embodiments of the system can have the processor configured to determine the plurality of artifacts for the software file by, among other things, converting the software file into an intermediate representation and determining at least one of the plurality of artifacts from the intermediate representation. Yet other embodiments have the processor also being configured to determine whether a patch for the software file exists by analyzing at least one of the reference artifacts associated with the identified reference software file. Certain additional embodiments have the processor also being configured to automatically apply the patch to the software file. Certain other embodiments have the processor also being configured to analyze the patch and the software file to determine a repair portion of the patch that corresponds to a repair of a flaw in the software file, and apply only the repair portion of the patch to the software file.

Additional embodiments of the present invention provide a system for identifying code, which includes an interface capable of communicating with a source having one or more software files, a storage device for storing a plurality of reference artifacts, and a processor communicatively coupled to the interface and the storage device, and configured to: cause one or more software files to be obtained, determine a plurality of artifacts for the one or more software files, access a database which stores a plurality of reference artifacts, and identify a program fragment for the one or more software files by matching the plurality of artifacts that correspond to the program fragment to the plurality of reference artifacts that correspond to the program fragment. For certain example embodiments, the program fragment has been identified in the database to correspond to a flaw. Examples of such flaws include a bug, a security vulnerability, and a protocol deficiency. These flaws can be within the one or more software files or can be related to one or more interfaces between the software files. Additional embodiments also can have the processor be configured to automatically repair the flaw in the one or more software files.

According to an additional embodiment of the present invention, provided is a non-transitory computer readable medium with an executable program stored thereon, wherein the program instructs a processing device to perform the following steps: obtain a software file, determine a plurality of artifacts for the software file, access a database which stores a plurality of reference artifacts for each of a plurality of reference software files, compare the plurality of artifacts to the plurality of reference artifacts, and identify the software file by identifying the reference software file having the plurality of reference artifacts that match the plurality of artifacts.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a flow diagram illustrating an example embodiment of a method for providing a corpus for software files.

FIG. 2 is a flow chart illustrating example processing to extract intermediate representation (IR) from input software files for the corpus in accordance with an embodiment of the present invention.

FIG. 3 is a block diagram illustrating hierarchical relationships amongst artifacts for software files in accordance with an embodiment of the invention.

FIG. 4 is a block diagram illustrating an example embodiment of a system for providing a corpus of artifacts for software files.

FIG. 5 is a block diagram illustrating an example embodiment of a method for identifying design patterns.

FIG. 6 is a flow diagram illustrating an example embodiment of a method for identifying flaws.

FIG. 7 is a block diagram illustrating the clustering of artifacts for identifying design patterns in accordance with an embodiment of the present invention.

FIG. 8 is a flow diagram illustrating an example embodiment of a method for identifying software files using a corpus.

FIG. 9 is a flow diagram illustrating an example embodiment of a method for identifying program fragments.

FIG. 10 is a block diagram illustrating a system using the corpus in accordance with an embodiment of the present invention.

### DETAILED DESCRIPTION OF THE INVENTION

A description of example embodiments of the invention follows. The entire teachings of any patent or publication cited herein are incorporated into this document by reference.

Software analysis in accordance with example embodiments of the present disclosure allows for knowledge to be leveraged from existing software files, including files that are from publicly available sources or that are proprietary software. This knowledge can then be applied to other software files, including to repair flaws, identify vulnerabilities, identify protocol deficiencies, or suggest code improvements.

Example embodiments of the present invention can be directed to varying aspects of software analysis, including creating, updating, maintaining, or otherwise providing a corpus of software files and related artifacts about the software files for the knowledge database. This corpus can be used for a variety of purposes in accordance with aspects of the present invention, including to identify automatically newer versions of software files, patches that are available for software files, flaws in files that are known to have these flaws, and known flaws in files that are previously unknown to contain these errors. Embodiments of the present invention also can leverage the knowledge from the corpus to address these problems.

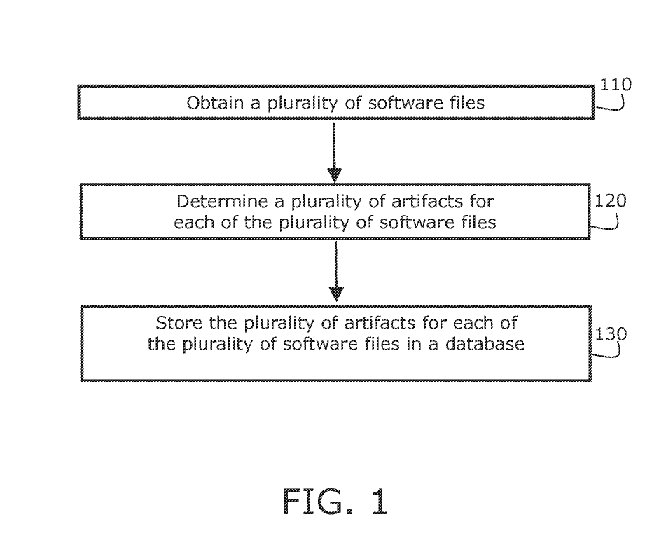

FIG. 1 is a flow chart illustrating example processing of input software files for the corpus in accordance with an embodiment of the present invention. The first illustrated step is to obtain a plurality of software files 110. These software files can be in a source code format, which typically is plain text, or in a binary code format, or some other format. Further, for certain example embodiments of the present invention the source code format can be any computer language that can be compiled, including Ada, C/C++, D, Erlang, Haskell, Java, Lua, Objective C/C++, PHP, Pure, Python, and Ruby. For certain additional example embodiments, interpreted languages can also be obtained for use with embodiments of the present invention, including PERL and bash script.

The software files obtained include not only the source code or binary files, but also can include any file associated with those files or the corresponding software project. For example, software files also include the associated build files, make files, libraries, documentation files, commit logs, revision histories, bugzilla entries, Common Vulnerabilities and Exposures (CVE) entries, and other unstructured text.

The software files can be obtained from a variety of sources. For example, software files can be obtained over a network interface via the Internet from publicly available software repositories such as GitHUB, SourceForge, BitBucket, GoogleCode, or Common Vulnerabilities and Exposures systems, such as the one maintained by the MITRE corporation. Generally, these repositories contain files and a history of the changes made to the files. Also, for example, a uniform resource locator (URL) can be provided to point to a site from which files can be obtained. Software files can also be obtained via an interface from a private network or locally from a local hard drive or other storage device. The interface provides for communicatively coupling to the source.

Example embodiments of the present invention can obtain some, most, or all files available from the source. Further, some example embodiments also automate obtaining files and, for example, can automatically download a file, an entire software project (e.g., revision histories, commit logs, source code), all revisions of a project or program, all files in a directory, or all files available from the source. Some embodiments crawl through each revision for the entire repository to obtain all of the available software files. Certain example embodiments obtain the entire source control repository for each software project in the corpus to facilitate automatically obtaining all of the associated files for the project, including obtaining each software file revision. Example source control systems for the repositories include Git, Mercurial, Subversion, Concurrent Versions System, BitKeeper, and Perforce. Certain embodiments can also continuously or periodically check back with the source to discern whether the source has been changed or updated, and if so, can just obtain the changes or updates from the source, or also obtain all of the software files again. Many sources have ways to determine changes to the source, such as date added or date changed fields that example embodiments may use in obtaining updates from a source.

Certain example embodiments of the present invention also can separately obtain library software files that may be used by the source code files that were obtained from the repositories to address the need for such files in case the repositories did not contain the libraries. Certain of these embodiments attempt to obtain any library software file reasonably available from any public source or obtained from a software vendor for inclusion in the corpus. Additionally, certain embodiments allow a user to provide the libraries used by software files or to identity the libraries used so that they can be obtained. Certain embodiments scrape the software files for each project to identify the libraries used by the project so that they can be obtained and also installed, if needed.

The next step in the example method in accordance with the present invention is determining a plurality of artifacts for each of the plurality of software files 120. Software artifacts can describe the function, architecture, or design of a software file. Examples of the types of artifacts include static artifacts, dynamic artifacts, derived artifacts, and meta data artifacts.

The final step of the example method is storing the plurality of artifacts for each of the plurality of software files in a database 130. The plurality of artifacts are stored in such a way that they can be identified as corresponding to the particular software file from which they were determined. This identification can be done in any of a well known variety of ways, such as a field in the database as represented by the database schema, a pointer, the location of where stored, or any other identifier, such as filename. Files that belong to the same project or build can similarly be tracked so that the relationship can be maintained.

For different embodiments, the database can take different forms such as a graph database, a relational database, or a flat file. One preferred embodiment employs OrientDB, which is a distributed graph database provided by the OrientDB Open Source Project lead by Orient Technologies. Another preferred embodiment employs Titan, which is a scalable graph database optimized for storing and querying graphs distributed across a multi-machine cluster, and the Apache Cassandra storage backend. Certain example embodiments can also employ SciDB, which is an array database to also store and operate on graph-artifacts, from Paradigm4.

The static artifacts, dynamic artifacts, derived artifacts, and meta data artifacts generally can be determined from source code files, binary files, or other artifacts. Examples of these types of artifacts are provided below. Example embodiments can determine one or more of these artifacts for the source code or binary software files. Certain embodiments do not determine each of these types of artifacts or each of the artifacts for a particular type, and instead may determine a subset of the artifact types and/or a subset of the artifacts within a type, and/or none of a particular type at all.

### Static Artifacts

Static artifacts for software files include call graphs, control flow graphs, use-def chains, def-use chains, dominator trees, basic blocks, variables, constants, branch semantics, and protocols.

A Call Graph (CG) is a directed graph of the functions called by a function. CGs represent high-level program structure and are depicted as nodes with each node of the graph representing a function and each edge between nodes is directional and shows if a function can call another function.

A Control Flow Graph (CFG) is a directed graph of the control flow between basic blocks inside of a function. CFGs represent function-level program structure. Each node in a CFG represents a basic block and the edges between nodes are directional and shows potential paths in the flow.

Use-Def (UD) and Def-Use Chains (DU) are directed acyclic graphs of the inputs (uses), outputs (definitions), and operations performed in a basic block of code. For example, a UD Chain is a use of a variable and all the definitions of that variable that can reach that use without intervening re-definition. A DU Chain is a definition of a variable and all the uses that can be reached from that definition without intervening re-definition. These chains enable semantic analysis of basic blocks of code with regard to the input types accepted, the output types generated, and the operations performed inside a basic block of code.

A Dominator Tree (DT) is a matrix representing which nodes in a CFG dominate (are in the path of) other nodes. For example, a first node dominates a second node if every path from the entry node to the second node must go through the first node. DTs are expressed in Pre (from entry forward) and Post (from exit backward) forms. DTs highlight when the path changes to a particular node in a CFG.

Basic Blocks are the instructions and operands inside each node of a CFG. Basic blocks can be compared, and similarity metrics between two basic blocks can be produced.

Variables are a unit of storage for information and its type, representing the types of information it can store, for any function parameters, local variables, or global variables, and includes a default value, if one is available. They can provide initial state and basic constraints on the program and show changes in the type or initial value, which can affect program behavior.

Constants are the type and value of any constant and can provide initial state and basic constraints on the program. They can show changes in the type or initial value, which can affect program behavior.

Branch Semantics are the Boolean evaluations inside of if statements and loops. Branches control the conditions under which their basic blocks are executed.

Protocols are the name and references of protocols, libraries, system calls, and other known functions used by the program.

Example embodiments of the present invention can automatically determine static artifacts from an intermediate representation (IR) of the software source code files such as provided by the publicly available LLVM (formerly Low Level Virtual Machine) compiler infrastructure project. LLVM IR is a low level common language that can represent high level languages effectively and is independent of instruction set architectures (ISAs), such as ARM, X86, X64, MIPS, and PPC. Different LLVM compilers, also termed front ends, for different computer languages can be used to transform the source code to the common LLVM IR. Front ends for at least Ada, C/C++, D, Erlang, Haskell, Java, Lua, Objective C/C++, PHP, Pure, Python, and Ruby are publicly available. Further, front ends for additional languages can be readily programmed. LLVM also has an optimizer available and back ends that can transform the LLVM IR into machine language for a variety of different ISAs. Additional example embodiments can determine static artifacts from the source code files.

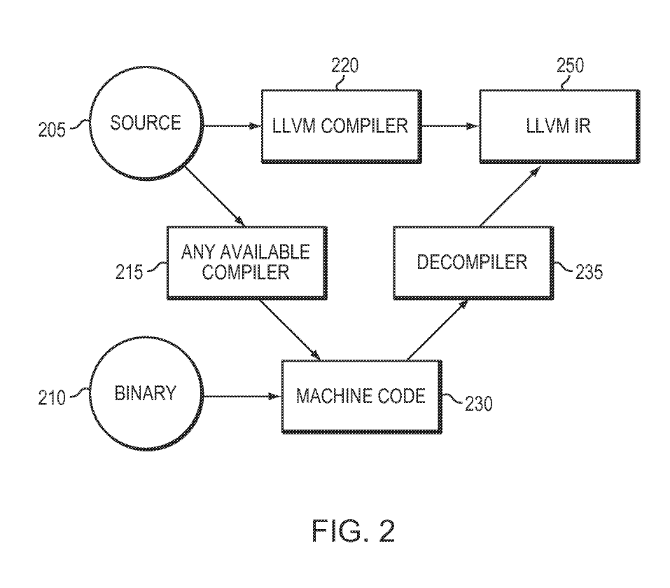

FIG. 2 is a flow chart illustrating additional example processing of input software files for the corpus that can be utilized in accordance with an embodiment of the present invention. Example embodiments can obtain, among other things, both source code 205 and binary code 210 software files. When a LLVM compiler 220 is available for the language of a source code file 205, the LLVM compiler 220 for that language can be used to translate the source code into LLVM IR 250. For compiled languages without an available LLVM compiler, the source code 205 can be first compiled into a binary file 230 with any supported compiler 215 for that language. Then, the binary file 230 is decompiled using a decompiler 235 such as Fracture, which is a publicly available open source decompiler provided by Draper Laboratory. The decompiler 235 translates the machine code 230 into LLVM IR 250. For files that are obtained in binary form 210, which is machine code 230, they are decompiled using the decompiler 235 to obtain LLVM IR 250. Example embodiments can extract language-independent and ISA-independent artifacts from the LLVM IR.

Example embodiments of the present invention can automatically obtain the IR for each of the source code software files. For example, the example embodiments can automatically search the repository for a project for a standard build file, such as autocomf, cmake, automake, or make file, or vendor instructions. The example embodiments can automatically selectively try to use such files to build the project by monitoring the build process and converting compiler calls into LLVM front end calls for the particular language of the source code. The selection process for the build files can step through each of the files to determine which exist and provide for a completed build or partially completed build.

Additional example embodiments can use a distributed computer system in automatically obtaining files from a repository, converting files to LLVM IR, and/or determining artifacts for the files. An example distributed system can use a master computer to push projects and builds out to slave machines to process. The slaves can each process the project, version, revision, or build they were assigned, and can translate the source or binary files to LLVM IR and/or determine artifacts and provide the results for storage in the corpus. Certain example embodiments can employ Hadoop, which is an open-source software framework for distributed storage and distributed processing of very large data sets. Obtaining of the files from a source repository can also be distributed amongst a group of machines.

The software files and the LLVM IR also can be stored in the corpus in accordance with example embodiments, including in distributed storage. Example embodiments also may determine that the software file or LLVM IR code is already stored in the database and choose to not store the file again. Pointers, edges in a graph database, or other reference identifiers can be used to associate the files with a particular project, directory, or other collection of files.

### Dynamic Artifacts

Dynamic artifacts are representative of program behavior and are generated by running the software in an instrumented environment, such as a virtual machine, emulators (e.g. quick emulator (“QEMU”), or a hypervisor. Dynamic artifacts include system call traces/library traces and execution traces.

A system call trace or library trace is the order and frequency in which system calls or library calls are executed. A system call is how a program requests a service from an operating system's kernel, which manages the input/output requests. A library call is a call to a software library, which is a collection of programming code that can be re-used to develop software programs and applications.

An execution trace is a per-instruction trace that includes instruction bytes, stack frame, memory usage (e.g., resident/working set size), user/kernel time, and other run-time information.

Example embodiments of the present invention can spawn virtual environments, including for a variety of operating systems, and can run and compile source code and binary files. These environments can allow for dynamic artifacts to be determined. For example, publicly available programs such as Valgrind or Daikon can be employed to provide run-time information about the program to serve as artifacts. Valgrind is a tool for, among other things, debugging memory, detecting memory leak, and profiling. Daikon is a program that can detect invariants in code; an invariant is a condition that holds true at certain points in the code.

Yet other embodiments can employ additional diagnostic and debugging programs or utilities, such as strace and dtrace, which are publicly available. Strace is used to monitor interactions between processes and the kernel, including system calls. Dtrace can be used to provide run-time information for the system, including the amount of memory used, CPU time, specific function calls, and the processes accessing a specific file. Example embodiments can also track execution traces (e.g., using Valgrind) across multiple runs of the program.

Additional embodiments can run the LLVM IR through the KLEE engine. KLEE is a symbolic virtual machine which is publicly available open source code. KLEE symbolically executes the LLVM IR and automatically generates tests which exercise all code program paths. Symbolic execution relates to, among other things, analyzing code to determine what inputs cause each part of the code to execute. Employing KLEE is highly effective at finding functional correctness errors and behavioral inconsistencies, and thus, allowing example embodiments of the present invention to rapidly identify differences in similar code (e.g., across revisions).

### Derived Artifacts

Derived artifacts are representative of complex, high-level program behaviors and extract properties and facts that are characteristic of these behaviors. Derived artifacts include Program Characteristics, Loop Invariants, Extended Type Information, Z Notation and Label Transition System representation.

Program Characteristics are facts about the program derived from execution traces. These facts include minimum, maximum, and average memory size; execution time; and stack depth.

Loop Invariants are properties which are maintained over all iterations (or a selected group of iterations) of a loop. Loop invariants can be mapped to the branch semantics to uncover similar behaviors.

Extended Type Information comprise facts about types, including the range of values a variable can hold, relationships to other variables, and other features that can be abstracted. Type constraints can reveal behaviors and features about the code.

Z Notation is based on Zermelo-Fraenkel set theory. It provides a typed algebraic notation, enabling comparison metrics between basic blocks and whole functions ignoring structure, order, and type.

Label Transition System (LTS) representation is a graph system which represents high-level states abstracted from the program. The nodes of the graph are states and the edges are labelled by the associated actions in the transition.

For certain example embodiments, derived artifacts can be determined from other artifacts, from the source code files, including using programs described above for dynamic artifacts, and from LLVM IR.

### Meta Data Artifacts

Meta data artifacts are representative of program context, and include the meta data associated with the code. These artifacts have a contextual relationship to the computer programs. Meta data artifacts include file names, revision numbers, time stamps of files, hash values, and the location of the files, such as belonging to a specific directory or project. A subset of meta data artifacts can be referred to as developmental artifacts, which are artifacts that relate to the development process of the file, program, or project. Developmental artifacts can include in-line code comments, commit histories, bugzilla entries, CVE entries, build info, configuration scripts, and documentation files such as README.* TODO.*.

Example embodiments can employ Doxygen, which is a publicly available documentation generator. Doxygen can generate software documentation for programmers and/or end users from specially commented source code files (i.e. inline code documentation).

Additional embodiments can employ parsers, such as a Another Tool For Language Recognition (ANTLR)4-generated parser, to produce abstract syntax trees (ASTs) to extract high-level language features, which can also serve as artifacts. ANTLR4 takes a grammar, production rules for strings for a language, and generates a parser that can build and walk parse trees. The resultant parsers emit the various types, function definitions/calls, and other data related to the structure of the program. Low-level attributes extracted with ANTLR4-generated parsers include complex types/structures, loop invariants/counters (e.g., from a for each paradigm), and structured comments (e.g., formal pre/post condition statements). Example embodiments can map this extracted data to its referenced locations in the LLVM IR because filename, line, and column number information exists in both the parser and LLVM IR.

Example embodiments of the present invention can automatically determine one or more meta data artifacts by extracting a string of characters, such as an in-line comment, from the source software files. Yet other embodiments automatically determine meta data artifacts from the file system or the source control system.

### Hierarchical Inter-Artifacts Relationships

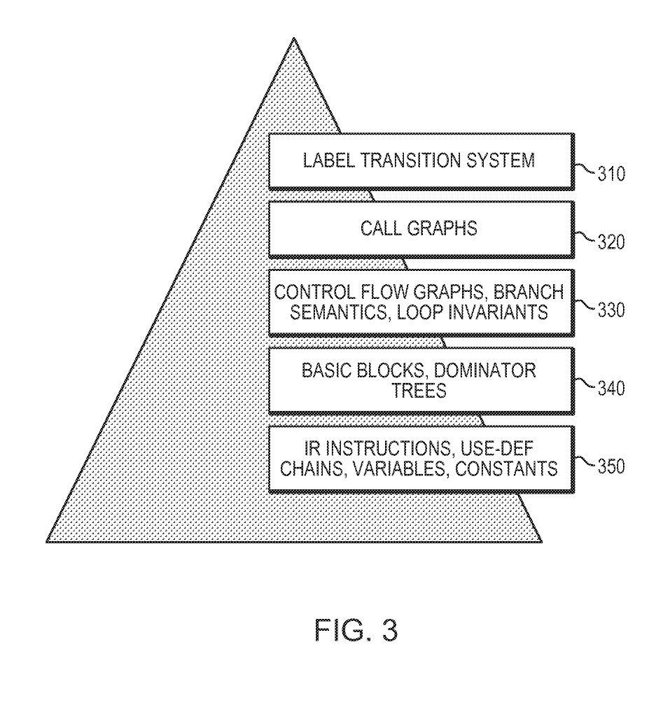

FIG. 3 is a block diagram illustrating hierarchical relationships amongst artifacts for software files in accordance with an embodiment of the invention. Example embodiments can maintain and exploit these hierarchical inter-artifact relationships. Further, different embodiments can use different schemas and different hierarchical relationships. For the example embodiment of FIG. 3, the top of the artifact hierarchy is the LTS artifact 310. Each LTS node 310 can map to a set or subset of functions and particular variable states. Under the LTS artifact 310 is the CG artifact 320. Each CG node 320 can map to a particular function with a CFG artifact 330 whose edges may contain loop invariants and branch semantics 330. Each CFG node 330 can contain basic blocks, and DTs 340. Beneath those artifacts are variables, constants, UD/DU chains, and the IR instructions 350. FIG. 3 clearly illustrates that artifacts can be mapped to different levels of the hierarchy, from an LTS node describing ranges of dynamic information down to individual IR instructions. These hierarchical relationships can be used by example embodiments for a variety of uses, including to search more efficiently for matching artifacts, such as by first comparing artifacts closer to the top of the hierarchy (as compared to artifacts closer to the bottom) so as to include or exclude entire sets of lower level artifacts associated with the higher level artifacts depending upon whether or not the higher level artifacts are a match. Additional embodiments can also utilize the hierarchical relationships in locating or suggesting repair code for flaws or for feature enhancements, including by going higher in the hierarchy to locate repair code for a flaw having matching higher level artifacts.

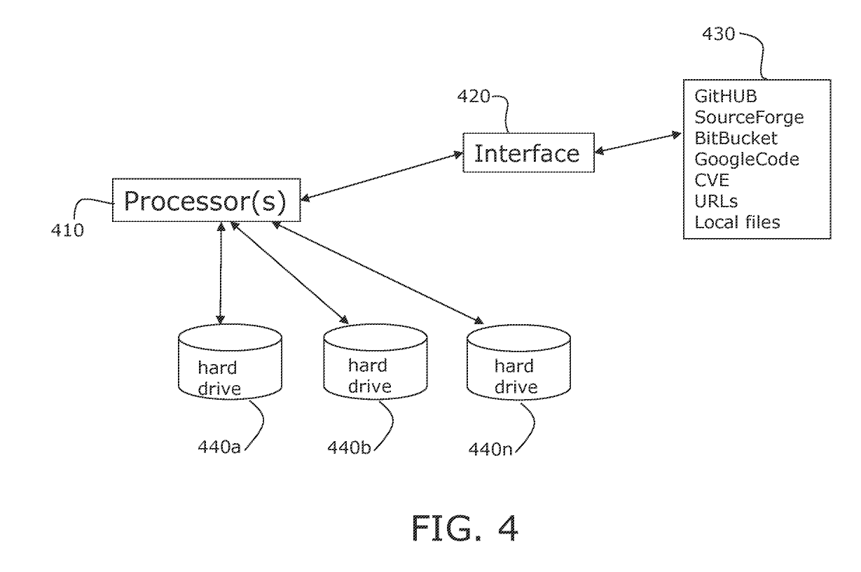

FIG. 4 is a block diagram illustrating an example embodiment of a system for providing a corpus of artifacts for software files. An example embodiment can have an interface 420 capable of communicating with a source 430 having a plurality of software files. This interface 420 can be communicatively coupled to a local source 430 such as a local hard drive or disk for certain embodiments. In other embodiments, the interface 420 can be a network interface 420 for obtaining files over a public or private network. Examples of public sources 430 of these software files include GitHUB, SourceForge, BitBucket, GoogleCode, or Common Vulnerabilities and Exposures systems. Examples of private sources include a company's internal network and the files stored thereon, including in shared network drives and private repositories. This example system also has one or more processors 410 coupled to the interface 420 to obtain the plurality of software files from the source 430. The processor 410 can also be used to determine the plurality of artifacts for each of the plurality of software files. These artifacts can be static, dynamic, derived, and/or meta data artifacts. For additional embodiments, the processor 410 can also be configured to convert each of the software files into an intermediate representation and to determine artifacts from the intermediate representation.

The example system also has one or more storage devices 440a-440n for storing the artifacts for each of the software files, and are coupled to the processor 410. These storage devices 440a-440n can be hard drives, arrays of hard drives, other types of storage devices, and distributed storage, such as provided by employing Titan and Cassandra on a Hadoop File System (HDFS). Likewise, the example system can have one processor 410 or employ distributing processing and have more than one processor 410. Yet other embodiments also provide from direct communicative coupling between the interface 420 and the storage devices 440a-440n.

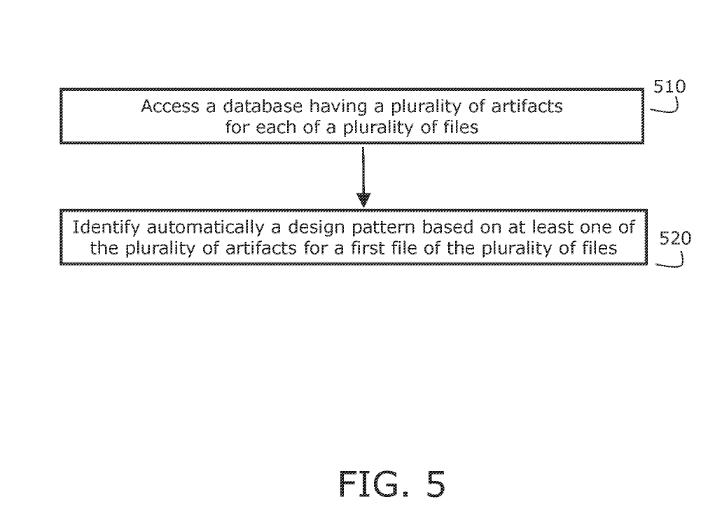

FIG. 5 is a block diagram illustrating an example embodiment of a method for locating design patterns. Examples of design patterns include bug, repair, vulnerability, security-patch, protocol, protocol-extension, feature, and feature-enhancement. Each design pattern can be associated with extracted artifacts (e.g., specifications, CG, CFG, Def-Use Chains, instruction sequences, types, and constants) at various levels of the software project hierarchy.

The example method provides accessing a database having multiple artifacts corresponding to multiple software files 510. The database can be a graph database, relational database, or flat file. The database can be located locally, on a private network, or available via the Internet or the Cloud. Once the database has been accessed, then the method can identify automatically a design pattern based on at least one of the plurality of artifacts for a first file of the plurality of files 520. For certain example embodiments, each of the plurality of artifacts can be static artifacts, dynamic artifacts, derived artifacts, or meta data artifacts. Other embodiments can have a mix of different types of artifacts. Further, the format of the files is not limited, and can be a binary code format, a source code format, or an intermediate representation (IR) format, for example.

For certain embodiments, the design patterns can be identified by key word searching or natural language searching of the developmental artifacts. For example, inline code comments in a revision of a source code file may identify a flaw that was found and fixed. The comments may use words such as flaw, bug, error, problem, defect, or glitch. These words could be used in key word searching of the meta data. Commit logs also can include text describing why new revisions and patches have been applied, such as to address flaws or enhance features. Further, training and feedback can be applied to the searching to refine the search efforts.

Additional example embodiments can search the developmental artifacts from CVE sources, which identify common vulnerabilities and errors in text and can describe the flaw and the available repairs, if any. This text can be obtained as an artifact and stored in the database. Certain sources also code the flaws so that code can be used as a key word to locate which file contains a flaw. Additionally, the source of the artifacts can be considered and weighted in the identification of a software file. For example, a CVE source may be more reliable in identifying flaws than a repository without provenance or in-line comments. Yet other embodiments may use meta data artifacts such as file name and revision number to at least preliminarily identify a software file and confirm the identification based on matching additional artifacts, such as, for example, CGs or CFGs.

Certain embodiments of the present invention perform the example method and try to identify design patterns for some, most, or all source code and LLVM IR files. Additionally, whenever files are added to the corpus, certain embodiments access the database and try to identify any design patterns. Certain embodiments can also label the identified design patterns for later use.

Certain embodiments also find the location of the flaw in the source code or the LLVM IR associated with the file that also has been stored in the database. For example, the developmental artifacts may specify where in the source code the flaw exists and where in a patch the repair exists. Also, the source code or LLVM IR can be analyzed and compared with the file having the flaw and the newer repaired version of the file for isolating the differences and discerning where the flaw and repair are located. For certain embodiments the type of flaw identified in the developmental artifact can also be used to narrow the search of the code for the location of the flaw. Additional embodiments also can identify the design pattern, such as using a label, and store the identifier in the database for the file. This allows the database to be readily searched for certain flaws or types of flaws. Examples of such labels include character strings obtained from the developmental artifacts for the software file or from the source code. This same approach can apply to identifying features and feature enhancements and labeling them.

For certain example embodiments, the design pattern is located in the software file. For certain example embodiments, the design pattern may relate to the interaction, such as interfaces, between files. Example embodiments can identify automatically the design pattern by basing the identification on artifacts for multiple software files, such as a first and second file which both belong to a software project. For example, a pre-identified pattern that denotes a design pattern, such as an interface mismatch error, can be stored in a database or elsewhere that allows artifacts from the first and second file to be used to identify that the interface error exists for these files. Example design patterns for example embodiments include a flaw, repair, feature, feature enhancement, or a pre-identified program fragment.

For certain example embodiments, the method locates in an artifact a character string that denotes a flaw or a repair. Often, such strings, such as bug, error, or flaw, are present in developmental artifacts, as well as strings regarding repairs and where those can be found in the code. These developmental artifacts also can have strings that denote a feature or a feature enhancement.

For certain example embodiments, the design patterns are based on a pre-identified pattern which denotes the design pattern. These pre-identified patterns can be created by a user, can be previously identified by methods associated with this disclosure, or can be identified in some other way. These pre-identified patterns can correspond to flaws, repairs, features, feature enhancements, or items of interest or other significance.

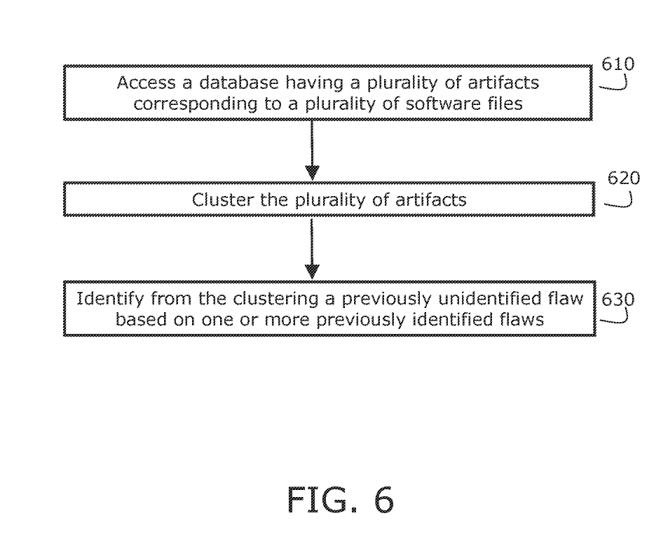

FIG. 6 is a flow diagram illustrating an example embodiment of a method for locating flaws. The method includes accessing a database, 610 such as the corpus, having a plurality of software artifacts corresponding to a plurality of software files. Then, the artifacts are analyzed to discern patterns from the volume of data. For example, this analysis can include clustering the plurality of artifacts 620. By clustering the data, known flaws in files that are not known to contain the known flaws can be found. Thus, from the clustering, the example method can identify a previously unidentified flaw based on one or more previously identified flaws 630.

Certain example embodiments of the present invention can employ machine learning to the corpus. Machine learning relates to learning hierarchical structures of the data by beginning with low level artifacts to capture related features in the data and then build up more complex representations. Certain example embodiments can employ deep learning to the corpus. Deep learning is a subset of the broader family of machine learning methods based on learning representations of data. For certain embodiments, autoencoders can be used for clustering.

For certain example embodiments, the artifacts can be processed by a set of autoencoders to automatically discover compact representations of the unlabeled graph and document artifacts. Graph artifacts include those artifacts that can be expressed in graph form, such as CGs, CFGs, UD chains, DU chains, and DTs. The compact representations of the graph artifacts can then be clustered to discover software design patterns. Knowledge extracted from the corresponding meta data artifacts can be used to label the design patterns (e.g., bug, fix, vulnerability, security-patch, protocol, protocol-extension, feature, and feature-enhancement).

For certain example embodiments, the autoencoders are structured sparse auto-encoders (SSAE), which can take vectors as input and extract common features. For certain embodiments to automatically discover features of a program, the extracted graph artifacts are first expressed in matrix form. Many of the extracted artifacts can be expressed as adjacency matrices, including, for example, CFG, UD chains, and DU chains. The structural features can be learned at each level of the software file and project hierarchy.

The number of nodes in the graph artifacts can vary widely; therefore, intermediate artifacts can be provided as input for deep learning. One such intermediate artifact is the first k eigenvalues of the Graph Laplacian, enabling the deep learning to perform processing akin to spectral clustering. Other intermediate artifacts include clustering coefficients, providing a measure of the degree to which nodes in a graph tend to cluster together, such as the global clustering coefficient, network average clustering coefficient, and the transitivity ratio. Another intermediate artifact is the arboricity of a graph, a measure of how dense the graph is. Graphs with many edges have high arboricity, and graphs with high arboricity have a dense subgraph. Yet another intermediate artifact is the isoperimetric number, a numerical measure of whether or not a graph has a bottleneck. These intermediate artifacts capture different aspects of the structure of the graph for use in machine learning methods.

Machine learning, including deep learning, for example embodiments can employ algorithms that are trained using a multi-step process starting with a simple autoencoder structure, and iteratively refining the approach to develop the SSAE. The SSAE also can be trained to learn features from the intermediate artifacts. An autoencoder learns a compact representation of unlabeled data. It can be modeled by a neural network, consisting of at least one hidden layer and having the same number of inputs and outputs, which learn an approximation to the identity function. The autoencoder dehydrates (encodes) the input signals to an essential set of descriptive parameters and rehydrates (decodes) those signals to recreate the original signals. The descriptive parameters can be automatically chosen during training to optimize rehydrating over all training signals. The essential nature of the dehydrated signals provides the basis for grouping signals into clusters.

Autoencoders can reduce the dimensionality of input signals by mapping them to a lower-dimensionality feature space. Example embodiments can then perform clustering and classification of the codes in the feature space discovered by the autoencoder. A k-means algorithm clusters learned features. The k-means algorithm is an iterative refinement technique which partitions the features into k clusters which minimize the resulting cluster means. The initial number of clusters, k, can be chosen based on the number of topics extracted. It is very efficient to search over the number of potential clusters, calculating a new result for each of many different k's, because the operating metric for k-means clustering is based on Euclidean distance. Example embodiments can classify the resultant clusters with the labels of the topics most frequently occurring within the software files from which the clustered features are derived.

Although the feature vector is sparse and compact, it can be difficult to understand the input vector merely by inspection of the feature vector. Thus, example embodiments can exploit the priors associated with previously learned weight parameters. Given a sufficient corpus, patterns in the parameter space should emerge e.g., for “repaired” code. Example embodiments can incorporate particular patterns into the autoencoder using prior information given by the data set collected up to that point. In particular, as labels are learned by the system, example embodiments can incorporate that information into the autoencoder operation.

Example embodiments can use a mixture of database management (e.g., joins, filters) and analytic operations (e.g., singular value decomposition (SVD), biclustering). Example embodiments' graph-theoretic (e.g., spectral clustering) and machine learning or deep learning algorithms can both use similar algorithm primitives for feature extraction. SVD also can be used to denoise input data for learning algorithms and to approximate data using fewer dimensions, and, thus, perform data reduction.

Example embodiments can encapsulate human understanding of the code state over time and across programs through unsupervised semantic label generation of document artifacts, including via text analytics. An example of text analytics is latent Dirichlet allocation (LDA). Semantic information can be extracted from the document artifacts using LDA and topic modeling. These approaches are “bag-of-words” techniques that look at the occurrences of words or phrases, ignoring the order. For example, a bag representing “scientific computing” may have seed terms such as “FFT,” “wavelet,” “sin,” and “atan.” The example embodiments can use the extracted document artifacts from sources such as source comments, CG/CFG node labels, and commit messages to fill “bags” by counting the occurrence of terms. The resulting fixed bin histogram can be fed to a Restricted Boltzmann Machine (RBM), an implementation of a deep learning algorithm appropriate for text applications. The extracted topics capture the semantic information associated with the extracted document artifacts and can serve as labels (e.g., bug/fix, vulnerability/patch) for the clusters formed by the unsupervised learning of graph-artifacts via the autoencoder. Other forms of text analytics that can be employed by additional example embodiments includes natural language processing, lexical analysis, and predictive analysis.

The topic labels extracted from the document artifacts can provide the labeling information to inform the structuring of the autoencoder. Example embodiments can query the corpus database for populations of training data based on learned topics, the semantic commonalities that represent ordinal software patterns (i.e., before/after software revisions). These patterns can capture changes embedded in software development files, such as in commit logs, change logs, and comments, which are associated with the software development lifecycle over time. The association of these changes provides insight into the evolution of the software relevant for detection and repair such as bugs/fixes, vulnerability/security patch, and feature/enhancement. This information also can be used to understand and label the knowledge automatically extracted from the artifact corpus.

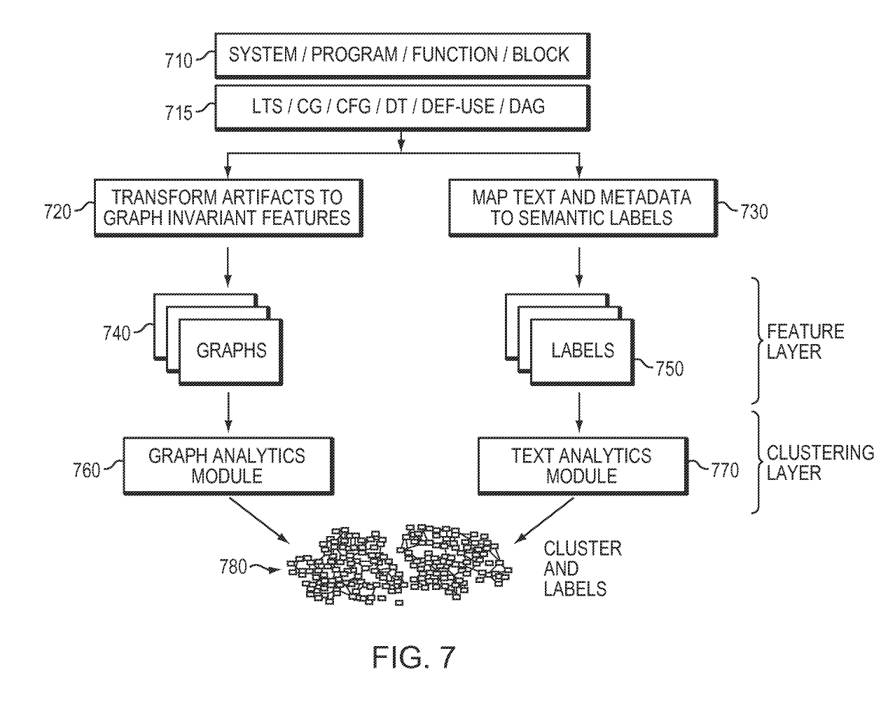

FIG. 7 shows a block diagram illustrating the clustering of artifacts for identifying design patterns in accordance with an embodiment of the present invention. The structural features can be learned at each level of the software file hierarchy, including system, program, function, and block 710. Graph artifacts, such as CGs, CFGs, and DTs, can be analyzed for the clustering 715. These graph artifacts can be transformed into graph invariant features 720. These graph features 740 can then be provided as input to a graph analytics module 760, such as an autoencoder, and the resultant clustering reviewed for the like design patterns, which are clustered together 780. Text, such as one or more strings of characters from source code files or from developmental artifacts, can be mapped to labels 730. These labels 750 can be analyzed by a text analytics module 770, such as by using LDA or other natural language processing, and the labels can be associated with the corresponding discovered clusters 780 from which the labels were derived. These modules 760, 770 can be realized in software, hardware, or combinations thereof.

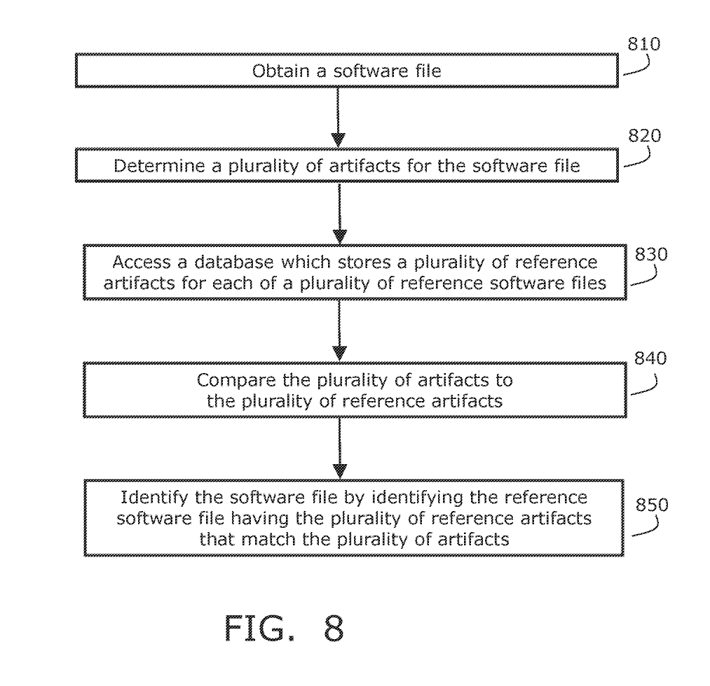

FIG. 8 shows a flow diagram illustrating an example embodiment of a method for identifying software using a corpus. The example embodiment obtains a software file 810. The file can be obtained via a network interface from a public or private source, such as a public repository via the Internet, the Cloud, or a private company's server. Certain example embodiments can also obtain the software file from a local source, such as a local hard drive, portable hard drive, or disk. Example embodiments can obtain a single file or multiple files from the source and can do so automatically, such as via the use of a scripting language, or manually with user interaction. The example method can then determine a plurality of artifacts for the software file 820, such as any of the other artifacts described herein. The example method can then access a database 830 which stores a plurality of reference artifacts for each of a plurality of reference software files. The reference artifacts can be stored in the corpus database. For certain example embodiments, these reference files can include the software files that have previously been obtained and whose artifacts have been stored in the database, along with the software files for certain embodiments. The artifacts, or plural subsets thereof, that have been determined for the obtained software file are compared to the reference artifacts, or plural subsets thereof, stored in the database 840. Example embodiments can identify the software file by identifying the reference software file having the plurality of reference artifacts that match the plurality of artifacts 850. Because the compared artifacts and reference artifacts match, the software file and the reference software file are identified as being the same file.

Additional artifacts or portions of code can also then be compared to increase the confidence level that the correct identification was made. The degree of confidence can be fixed or adjustable and can be based on a wide variety of criteria, such as the number of artifacts that match, which artifacts match, and a combination of number and which artifacts. This adjustment can be made for particular data sets and observations thereof, for example. Furthermore, for certain embodiments matching can include fuzzy matching, such as having an adjustable setting for a percentage less than 100% of matching, to have a match declared.

For certain example embodiments, certain artifacts can be given more or less weight in the matching and identification process. For example, common artifacts, such as whether the instructions are associated with a 32 bit or 64 bit processor, can be given a weight of zero or some other lesser weight. Some artifacts can be more or less invariant under transformation and the weights for these artifacts can be adjusted accordingly for certain example embodiments. For example, the filename or CG artifact may be considered highly informative in establishing the identity of a file while certain artifacts, such as LTS or DTs, for example, can be considered less dispositive and given less weight for certain example embodiments and sources. Additional embodiments can give certain combinations of artifacts more weight to identify a match when making comparisons. For example, having the CFG and CG artifacts match may be given more weight in making an identification than having basic block artifacts and DT artifacts match. Likewise, certain artifacts not matching may be given more or less weight in making an identification of a file. Additional examples of evaluating weighting in the identification process can include expressing an identification threshold, such as in percentages of matching artifacts or some other metric. Additional embodiments can vary the identification threshold, including based on such things as the source of the file, the type of the file, the time stamp, which includes the date of the file, the size of the file, or whether certain artifacts cannot be determined for the file or are otherwise unavailable.

Additional embodiments can determine some of the plurality of artifacts for the software file by converting the software file into an intermediate representation, such as LLVM IR, and determining at least one of the plurality of artifacts from the intermediate representation. Yet other embodiments can determine some of the plurality of artifacts by extracting a character string from the software file, such as a source code file or documentation file.

Example embodiments can also include determining whether a newer version of the software file exists by analyzing at least one of the reference artifacts associated with the identified reference software file. For example, once the software file has been identified, the database can be checked to see whether a newer revision of the software file is available, such as by checking the revision number or time stamp of the corresponding reference file, or the labels associated with artifacts and files in the database that can identify the reference file as an older revision of another file. Additional example embodiments can also automatically provide the newer version of the software file, including to a user or a public or private source.

Certain additional embodiments can determine whether a patch for the software file exists by analyzing at least one of the reference artifacts associated with the identified reference software file. For example, the example embodiments can check an artifact associated with the reference software file and determine that a patch exists for the file, including a patch that has not yet been applied to the software file. Additional embodiments can automatically apply the patch to the software file or prompt a user as to whether they want the patch applied.

Certain additional embodiments can analyze the patch, and also the software file (or the reference software file because they are matched) for certain embodiments, to determine a repair portion of the patch that corresponds to a repair of a flaw in the software file. This analysis can occur before or after the software file is obtained for certain embodiments. Additional embodiments can apply only the repair portion of the patch to the software file, including automatically or prompting a user as to whether they what the repair portion of the patch applied. Additional embodiments can provide the repair portion of the patch to the source for it to be applied at the source. Further, the analysis of the patch and the software file can include converting the patch and the software file into an intermediate representation and determining at least one of the plurality of artifacts from the intermediate representation. Similarly, additional embodiments can analyze the patch and the software file (or the reference software file because they are matched) to determine a feature enhancement portion of the patch that corresponds to an improvement or change of a feature in the software file. Additional embodiments can apply only the feature enhancement portion of the patch to the software file, including automatically or prompting a user as to whether they want the feature enhancement portion of the patch applied.

Additional example embodiments can determine whether a flaw exists in the software file by analyzing at least one of the reference artifacts associated with the identified reference software file. For example, the reference software file can have an artifact that identifies it as having a flaw for which a repair is available. Additional embodiments can automatically repair the flaw in the software file, including by automatically replacing a block of source code with a repair block of source code or a block of intermediate representation in the software file with a repair block of intermediate representation. Additional embodiments can repair the flaw in a binary file by replacing a portion of the binary with a binary patch. For certain embodiments, the repaired file can be sent to the source of the software file. Additional embodiments can provide for the repair code to be provided to the source of the software file for the file to repaired there.

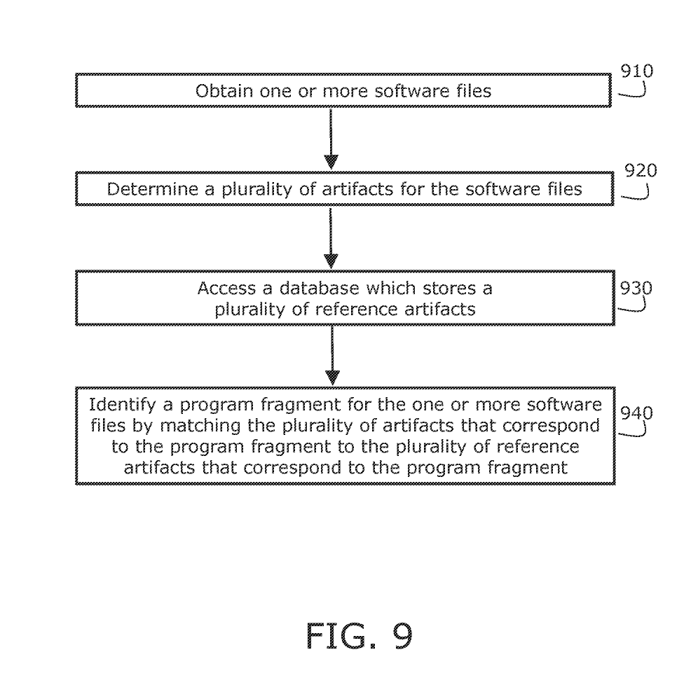

FIG. 9 is a flow diagram illustrating an example embodiment of a method for identifying code. The example method can obtain one or more software files 910. For the software files, a plurality of artifacts can be determined 920. Certain embodiments can instead obtain the artifacts rather than determining the artifacts if they have already been determined. A database can be accessed which stores a plurality of reference artifacts 930. The reference artifacts are artifacts as described herein and can correspond to reference software files, reference design patterns, or other blocks of code of interest. The database can be stored in many locations, such as locally, or on a network drive, or accessible over the Internet or in the Cloud, and also can be distributed across a plurality of storage devices. Then, a program fragment that is in the one or more software files, or associated with them such as interface bugs, can be identified by matching the plurality of artifacts that correspond to the program fragment to the plurality of reference artifacts that correspond to the program fragment 940. A program fragment is a sub portion of a file, program, basic block, function, or interfaces between functions. A program fragment can be as small as a single instruction or as large as the entire file, program, basic block, function, or interface. The portions chosen can be sufficient to identify the program fragment with any desired degree of confidence, which can be set or adjustable for certain embodiments, and which can vary, such as described above with respect to identifying files.

For certain embodiments, determining artifacts for the software file includes converting the software file into an intermediate representation and determining at least one of the artifacts from the intermediate representation. For certain embodiments, the software file and the reference software file are each in a source code format or are each in a binary code format. For additional embodiments, the program fragment corresponds to a flaw in the software file and has been identified in the database to correspond to the flaw. Additional embodiments can automatically repair the flaw in the software file or offer one or more repair options to a user to repair the flaw. Certain embodiments can order repair options, including, for example, based on one or more previous repair options selected by the user or based on the likelihood of success for the repair option.

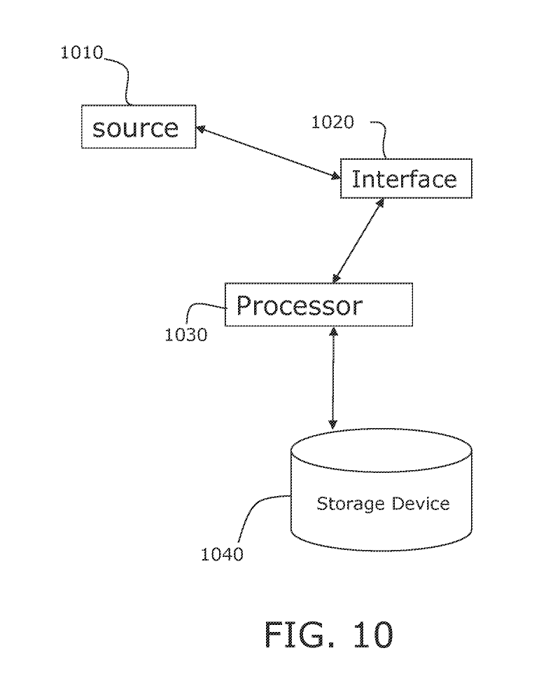

FIG. 10 is a block diagram illustrating a system using a database corpus of software files in accordance with an embodiment of the present invention. The example system includes an interface 1020 that can communicate with a source 1010 that has at least one software file. The interface 1020 is also communicatively coupled to a processor 1030. For additional embodiments, the interface 1020 can also be coupled directly to a storage device 1040. This storage device 1040 can be a wide variety of well known storage devices or systems, such as a networked or local storage device, such as a single hard drive, or a distributed storage system having multiple hard drives, for example. The storage device 1040 can store reference artifacts, including for each of a number reference software files and can be communicatively coupled to the processor 1030. The processor 1030 can be configured to cause a software file to be obtained from the source 1010. The identity of this software file and whether there are newer versions of the file available, whether there are patches available, or whether the file contains flaws or unenhanced features are examples of questions that the example system can address. The processor 1030 is also configured to determine a plurality of artifacts for the software file, access the reference artifacts in the storage device 1040, compare the artifacts for the software file to the reference artifacts stored in the storage device 1040, and identify the software file by identifying the reference software file having the reference artifacts that correspond to the compared artifacts for the software file.

In additional embodiments of the example system, the processor 1030 can be configured to automatically apply a patch to the software file if one is available in the storage device 1040 for the file. In yet additional embodiments, the processor also can be configured to analyze an identified patch and the software file to determine if there is a repair portion of the patch that corresponds to a repair of a flaw in the software file, and, if so, automatically apply only the repair portion of the patch to the software file, or prompt a user.

The block diagram of FIG. 10 also can illustrate another example system using a database corpus in accordance with an embodiment of the present invention. This other illustrated example system includes an interface 1020 that can communicate with a source 1010 that has one or more software files. The interface 1020 is also communicatively coupled to a processor 1030. For additional embodiments, the interface 1020 can also be coupled directly to a storage device 1040. This storage device 1040 can be a wide variety of well known storage devices or systems, such as a networked or local storage device, such as a single hard drive, or a distributed storage system having multiple hard drives, for example. The storage device 1040 can store reference artifacts and can be communicatively coupled to the processor 1030. The processor 1030 can be configured to cause one or more software files to be obtained, to determine a plurality of artifacts for the one or more software files, to access a database which stores a plurality of reference artifacts, and to identify a program fragment for the one or more software files by matching the plurality of artifacts that correspond to the program fragment to the plurality of reference artifacts that correspond to the program fragment. For certain example embodiments, the program fragment has been identified in the database to correspond to a flaw. Examples of such flaws include a bug, a security vulnerability, and a protocol deficiency. These flaws can be within the one or more software files or can be related to one or more interfaces between the software files. Additional embodiments also can have the processor be configured to automatically repair the flaw in the one or more software files. For certain example embodiments, the program fragment has been identified in the database to correspond to a feature and certain embodiments can also automatically provide a feature enhancement, including in the form of a patch for a source code or binary file.

### Repairs

Example embodiments support program synthesis for automated repair, including by replacing CG nodes (functions), CFG nodes (basic blocks), specific instructions, or specific variables and constants to instantiate selected repairs. These elements (e.g., function, basic block, instruction) are swappable with elements that have compatible interfaces (i.e., the same number of parameters, types, and outputs) and can transform the LLVM IR by replacing a flaw bock of LLVM IR with a repair block of LLVM IR.

Certain embodiments can also elect to swap a basic block with a function call and a function call with one or more basic blocks. Certain embodiments can patch source code and binaries. Additional embodiments can also create suitable elements for swap when they do not already exist. High level artifacts (e.g., LTS and Z predicates) can be used to derive compatible implementations for the software patches. Example embodiments can exploit the hierarchy of the extracted graph representations, first ascending the hierarchy to a suitable representation of the repair pattern, and then descending the hierarchy (via compilation) to a concrete implementation. The hierarchical nature of the artifacts can help in fashioning the repair code.

Example embodiments can allow a user to submit a target program (either source or binary) and example embodiments discover the existence of any flaw design patterns. For each flaw, candidate repair strategies (i.e., repair design patterns) can be provided to the user. The user can select a strategy for the repair to be synthesized and the target to be patched. Certain example embodiments also can learn from the user selections to best rank future repair solutions, and repair strategies can also be presented to the user in ranked order. Certain embodiments also can run autonomously, repairing flaws or vulnerabilities over the entire software corpus, including continuously, periodically, and/or in the design environment.

In addition to the embodiments discussed above, the present invention can be employed for a wide variety of uses. For example, example embodiments can be used during programming of software code to assistant the programmer, including to identify flaws or suggest code re-use. Additional example embodiments can be used for discovering flaws and vulnerabilities and optionally automatically repairing them. Yet other example embodiments can be used to optimize code, including to identify code that is not used, inefficient code, and suggest code to replace less efficient code.

Example embodiments can also be used for risk management and assessment, including with respect to what vulnerabilities may exist in certain code. Additional embodiments may also be used in the design certification process, including to provide certification that software files are free from known flaws, such as bugs, security vulnerabilities, and protocol deficiencies.

Yet still other additional example embodiments of the present invention include: code re-use discoverer (finding code which does the same thing already in your codebase), code quality measurement, text-description to code translator, library generator, test-case generator, code-data separator, code mapping and exploration tool, automatic architecture generation of existing code, architecture improvement suggestor, bug/error estimator, useless code discovery, code-feature mapping, automated patch reviewer, code improvement decision tool (map feature list to minimal changes), extension to existing design tools (e.g., enterprise architect), alternate implementation suggestor, code exploration and learning tool (e.g., for teaching), system level code license footprint, and enterprise software usage mapping.

It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general purpose computer is transformed into the machines that execute the methods described above, for example, by loading software instructions into a data processor, and then causing execution of the instructions to carry out the functions described, herein. The software instructions may also be modularized, such as having an ingest module for ingesting files to form a corpus, an analytics module to determine artifacts for files for the corpus and/or files to be identified or analyzed for design patterns, a graph analytics module and a text analytics module to perform machine learning, an identification module for identifying files or design patterns, and a repair module for repairing code or providing updated or repaired files. These modules can be combined or separated into additional modules for certain example embodiments.

As is known in the art, such a computer may contain a system bus, where a bus is a set of hardware lines used for data transfer among the components of a computer or processing system. The bus or busses are essentially shared conduit(s) that connect different elements of the computer system, e.g., processor, disk storage, memory, input/output ports, network ports, etc., which enables the transfer of information between the elements. One or more central processor units are attached to the system bus and provide for the execution of computer instructions. Also attached to system bus are typically I/O device interfaces for connecting various input and output devices, e.g., keyboard, mouse, displays, printers, speakers, etc., to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof. Furthermore, example embodiments may wholly or partially reside on the Cloud and can be accessible via the Internet or other networking architectures.

In certain embodiments, the procedures, devices, and processes described herein constitute a computer program product, including a non-transitory computer-readable medium, e.g., a removable storage medium such as one or more DVD-ROM's, CD-ROM's, diskettes, tapes, etc., that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method for identifying software comprising:
obtaining a software file;
determining a plurality of artifacts for the software file;
accessing a database which stores a plurality of reference artifacts for each of a plurality of reference software files;
comparing the plurality of artifacts to the plurality of reference artifacts; and
identifying the software file by identifying the reference software file having the plurality of reference artifacts that match the plurality of artifacts.

2. The method of claim 1 wherein the plurality of artifacts includes one or more of a call graph, control flow graph, use-def chain, def-use chain, dominator tree, basic block, variable, constant, branch semantic, and protocol.

3. The method of claim 1 wherein the plurality of artifacts includes one or more of a system call trace and execution trace.

4. The method of claim 1 wherein the plurality of artifacts includes one or more of a loop invariant, type information, Z notation, and label transition system representation.

5. The method of claim 1 wherein the plurality of artifacts includes one or more artifacts determined from any of an in-line code comment, commit history, documentation file, and common vulnerabilities and exposure source entry.

6. The method of claim 1 wherein the plurality of artifacts are each a graph artifact.

7. The method of claim 1 wherein the plurality of artifacts are each a meta data artifact.

8. The method of claim 1 wherein the plurality of reference artifacts match the plurality of artifacts when at least a fuzzy match exists between the plurality of reference artifacts and the plurality of artifacts.

9. The method of claim 1 wherein determining the plurality of artifacts for the software file includes converting the software file into an intermediate representation and determining at least one of the plurality of artifacts from the intermediate representation.

10. The method of claim 1 further comprising determining whether a newer version of the software file exists by analyzing at least one of the reference artifacts associated with the identified reference software file.

11. The method of claim 10 further comprising automatically providing the newer version of the software file.

12. The method of claim 1 further comprising determining whether a patch for the software file exists by analyzing at least one of the reference artifacts associated with the identified reference software file.

13. The method of claim 12 further comprising automatically applying the patch to the software file.

14. The method of claim 12 further comprising analyzing the patch to determine a repair portion of the patch that corresponds to a repair of a flaw in the software file, and applying only the repair portion of the patch to the software file.

15. The method of claim 14 wherein analyzing the patch includes converting the patch into an intermediate representation and determining at least one patch artifact from the intermediate representation.

16. The method of claim 1 further comprising determining whether a flaw exists in the software file by analyzing at least one of the reference artifacts associated with the identified reference software file and at least one of the artifacts associated with the software file.

17. The method of claim 16 further comprising automatically repairing the flaw in the software file.

18. The method of claim 17 wherein automatically repairing the flaw comprises replacing a block of source code with a repair block of source code.

19. The method of claim 17 wherein automatically repairing the flaw comprises replacing a block of binary code with a repair block of binary code.

20. The method of claim 17 wherein automatically repairing the flaw comprises replacing a block of intermediate representation in the software file with a repair block of intermediate representation.

21. A method comprising:
obtaining one or more software files;
determining a plurality of artifacts for the one or more software files;
accessing a database which stores a plurality of reference artifacts; and
identifying a program fragment for the one or more software files by matching the plurality of artifacts that correspond to the program fragment to the plurality of reference artifacts that correspond to the program fragment.

22. The method of claim 21 wherein the program fragment has been identified in the database to correspond to a flaw.

23. The method of claim 21 wherein the program fragment corresponds to a flaw in the one or more software files.

24. The method of claim 21 wherein the program fragment corresponds to a flaw that is selected from the group consisting of a bug, a security vulnerability, and a protocol deficiency.

25. The method of claim 23 further comprising automatically repairing the flaw in the one or more software files.

26. The method of claim 25 wherein automatically repairing the flaw includes providing a repair program fragment to replace a flaw program fragment.

27. The method of claim 23 further comprising offering one or more repair options to a user to repair the flaw.

28. The method of claim 27 further comprising ordering the one or more repair options offered to the user.

29. The method of claim 28 wherein the ordering of the one or more repair options is based on one or more previous repair options selected by the user.

30. The method of claim 28 wherein the ordering of the one or more repair options is based on a likelihood of success for each of the repair options.

31. The method of claim 21 wherein the program fragment has been identified in the database to correspond to a feature.

32. The method of claim 31 further comprising automatically augmenting the feature with a feature enhancement.

33. The method of claim 21 wherein the plurality of artifacts include a graph artifact.

34. The method of claim 21 wherein the plurality of artifacts include a developmental artifact.

35. The method of claim 21 wherein the plurality of artifacts each are a meta data artifact.

36. The method of claim 21 wherein determining the plurality of artifacts for the one or more software files includes converting the one or more software files into an intermediate representation and determining at least one of the plurality of artifacts from the intermediate representation.

37. The method of claim 21 wherein the one or more software files are each in a source code format.

38. The method of claim 21 wherein the one or more software files are each in a binary code format.

39. The method of claim 21 wherein the one or more software files are files within a software project.

40. A system for identifying software comprising:
an interface capable of communicating with a source having a software file;
a storage device which stores a plurality of reference artifacts for each of a plurality of reference software files; and
a processor communicatively coupled to the interface and the storage device, and configured to:
cause the software file to be obtained;
determine a plurality of artifacts for the software file;
access the plurality of reference artifacts in the storage device;
compare the plurality of artifacts to the plurality of reference artifacts; and
identify the software file by identifying the reference software file having the plurality of reference artifacts that matched the plurality of artifacts.

41. The system of claim 40 wherein determine the plurality of artifacts for the software file includes converting the software file into an intermediate representation and determining at least one of the plurality of artifacts from the intermediate representation.

42. The system of claim 40 further comprising the processor also being configured to determine whether a patch for the software file exists by analyzing at least one of the reference artifacts associated with the identified reference software file.

43. The system of claim 40 further comprising the processor also being configured to automatically apply a patch to the software file.

44. The system of claim 42 further comprising the processor also being configured to analyze the patch to determine a repair portion of the patch that corresponds to a repair of a flaw in the software file, and apply only the repair portion of the patch to the software file.

45. A system comprising:
an interface capable of communicating with a source having one or more software files;
a storage device which stores a plurality of reference artifacts; and
a processor communicatively coupled to the interface and the storage device, and configured to:
cause one or more software files to be obtained;
determine a plurality of artifacts for the one or more software files;
access a database which stores a plurality of reference artifacts; and
identify a program fragment for the one or more software files by matching the plurality of artifacts that correspond to the program fragment to the plurality of reference artifacts that correspond to the program fragment.

46. The system of claim 45 wherein the program fragment has been identified in the database to correspond to a flaw.

47. The system of claim 45 wherein the program fragment corresponds to a flaw that is selected from the group consisting of a bug, a security vulnerability, and a protocol deficiency.

48. The system of claim 45 further comprising the processor also being configured to automatically repair the flaw in the one or more software files.

49. A non-transitory computer readable medium with an executable program stored thereon, wherein the program instructs a processing device to perform the following steps:
obtain a software file;
determine a plurality of artifacts for the software file;
access a database which stores a plurality of reference artifacts for each of a plurality of reference software files;
compare the plurality of artifacts to the plurality of reference artifacts; and
identify the software file by identifying the reference software file having the plurality of reference artifacts that match the plurality of artifacts.

50. A non-transitory computer readable medium with an executable program stored thereon, wherein the program instructs a processing device to perform the following steps:
obtain one or more software files;
determine a plurality of artifacts for the one or more software files;
access a database which stores a plurality of reference artifacts; and
identify a program fragment for the one or more software files by matching the plurality of artifacts that correspond to the program fragment to the plurality of reference artifacts that correspond to the program fragment.
